(19) United States
(12) Patent Application Publication
(10) Pub. No.: US 2006/0291203 A1
(43) Pub. Date: Dec. 28, 2006

(54) Fiber mixed R-G-B white emitting LED package

(76) Inventor: Munisamy Anandan, Del Valle, TX (US)

Correspondence Address: Dr. M. Anandan, 13009 Thome Valley Dr., Del Valle, TX, 78617, US

(21) Appl. No.: 11/454,098

(22) Filed: Jun. 16, 2006

Related U.S. Application Data
(60) Provisional application No. 60/694,453, filed on Jun. 27, 2005.

(51) Int. Cl. F21V 7/04; F21V 9/00

(52) U.S. Cl. 362/231; 362/554; 362/555

(57) ABSTRACT

A fiber bundle mixed R-G-B white LED package incorporating LEDs, an LED container and a fiber bundle, the fiber bundle being hermetically sealed to the LED container, enclosing Nitrogen, for thoroughly mixing colored light from LEDs and converting colored light in to white light and directing the beam of light emerging the exit face of the fiber bundle in any desired angle. Colored light from different color LEDs get pre-mixed inside the container through multiple reflections at the walls of the container and enter the fibers and undergo total internal reflections at the inner walls of the fibers and thus all the remaining unmixed or partly mixed light get mixed thoroughly and emerge the exit face of the fiber bundle as white light. Multiplicity of fiber mixed R-G-B white LED package can be employed for manufacturing (i) backlight for Liquid Crystal Displays (ii) large area bill board displays (iii) light sources for consumer lighting (iv) light sources for automobile lighting and (v) light sources for bridge lighting.

### BACKGROUND OF THE INVENTION

1. Field of Invention

Semiconductor based white Light Emitting Diodes (LEDs) are increasingly becoming efficient with proven long life and reliability. These are being used in consumer lighting replacing incandescent lamp. Flash lights are employing white LEDs. Auto dash boards are employing white LEDs. Liquid Crystal Displays (LCDs) are backlit by white LEDs. As for example in cell phones and digital cameras, the backlight for LCDs is mostly white LEDs.

White Light Emitting Diode (LED), based on semiconductor technology, is classified in to two families. The first one belongs to the phosphor converted white and the second one belongs to the three-color mixed white. Three color mixed white is obtained by employing red emitting LED, blue emitting LED and green emitting LED and mixing the emitted colors in the ratio of green:red:blue=64:28:8. To have this ratio from LED's emission, LEDs have to be properly powered. The LEDs need to be arranged physically in such a way that the rays emitted by the three color LEDs are mixed. The resulting mix gives the appearance of white light. This white light contains the spectrum emitted by the three red (R), blue (B) and green (G) LEDs. The white light can be used for consumer lighting as well as for backlighting LCDs. For LCD backlighting application, the mixing of colors is very important. A backlight unit consisting of specially packaged LEDs, light guide and other optical components such as prism sheet and diffusers are needed. The backlight unit is planar in geometry with certain thickness. Color mixing is accomplished inside the backlight device through proper packaging of LEDs and the optical components around LEDs. Certain minimum thickness of backlight unit is necessary for complete color mixing. Uniformity of color mixing is measured by measuring the chromaticity coordinates of the planar white light that finally emerges and travel towards LCD. Over large area of backlight unit, for example 32″ diagonal with aspect ratio of 3:2, the chromaticity coordinates (x and y) should not vary beyond third decimal place. This should happen with a thickness of backlight unit as small as possible. For LCD backlighting color mixing within minimum thickness of backlight unit is always a problem.

2. Description of Prior Art

Prior art has dealt with the problem of color mixing by having three color R-G-B LEDs emit their light sideward and downward towards a reflecting surface and the reflected light contained the mix of all three colors. To make the R-G-B LEDs emit their light sideward or downward, a specially designed lens structure is always employed over individual LEDs.

For example in one prior art (U.S. Pat. No. 6,679,621) West et.al described unique lens over each color LED and directed the reflected and refracted rays through the lens sideward and downward. LEDs of different colors are placed adjacent with certain pitch. This lens structure was exploited by Wiep Folkerts (“LED backlight concepts with high flux LEDs”—SID '04 Digest of Technical papers, pp. 1226-1229, May, 2004) for building a backlight for LCD. In the backlight unit the color rays going sideward and downward from the lens, cris-cross each other and fall on a planar reflecting surface. After reflection and before reflection the rays are mixed and finally the rays travel upwards towards a thick diffuser for further mixing. Diffusers impose light losses after mixing. In the unique lens employed by West et.al there are 5% of rays traveling straight upward without getting mixed with other colors and these rays contribute to non-uniformity in color on the backlight unit. The function of the lens in this case is only to redirect the rays from LED sideward and the mixing of colors is done through reflection at a surface below the lens. The color mixing is not complete and hence a thick diffuser is necessary.

In another prior art (U.S. Pat. No. 7,034,343) Kim Jin Ha et. al described an improved version of the lens placed on top of LED that is called ‘dipolar side-emitting lens’ that minimizes the % of rays escaping straight upwards. This lens also depends on the color mixing through reflections at the surface below the level of the lens and through the space in between adjacent LEDs. This also requires a thick diffuser for complete color mixing.

Yet another prior art (US Patent Application No. 20050264716) Kim Hyung Suk et. al described still improved version of ‘dipolar side-emitting lens’ that had ‘quadrupolar’ structure and the LED chip is placed at the center of the lens. This structure also relied on complete mixing of colors at the reflecting surface and thick diffuser.

In all the foregoing inventions, there is a certain thickness of backlight unit that is necessary to have complete color mixing and a thick diffuser is necessary for thorough mixing of colors. It is well known that thick diffusers impose light loss.

### BRIEF SUMMARY OF THE INVENTION

According to the present invention, complete mixing of colors emitted by LEDs to obtain white light can be accomplished without the use of complex lens structure and thick diffuser that imposes light loss but with the use of tapered fiber optic bundle packaged over a three-in-one R-G-B LED package. Pre-mixing of colors take place inside the three-in-one LED package and after pre-mixing the rays are incident on the input face of a tapered single core of multi-core fiber bundle and undergo multiple total internal reflections inside each fiber. All the three color rays go inside each fiber and get thoroughly mixed. As the total internal reflection leads close to zero loss of light, the mixing of colors is efficient. Finally the white light exits at the fanned-out end of the multi-core fiber bundle. In this configuration none of the rays travel sideward or downward. Instead the rays go upward. As the rays are pre-mixed and further mixed in the single core or multi-core fiber bundle, there is no need for a thick diffuser that imposes light loss, for further mixing. The tapered fiber bundle is sealed to the three-in-one LED package hermetically. Each LED package with fiber bundle acts as a white light source and the white light is well spread out due to the fanned-out structure of the exit face of the fiber bundle. Several of these LED packages with fiber bundle sealed to the package can be assembled with certain pitch to form a backlight unit. Due to these advantages the thickness of backlight unit is less than that obtained in the prior arts.

It is an object of this invention to provide a three-in-one R-G-B LED package with fanned-out fiber bundle that mixes red, blue and green colors of light emitted by R-G-B LEDs and gives out white light.

A further object of this invention is to provide a backlight unit for backlighting LCDs by incorporating multiplicity of fiber bundle packaged three-in-one R-G-B LEDs in a light box for direct-lit mode or at the side of a light guide for edge-lit mode.

Yet another object of this invention is to provide a backlight unit for backlighting LCDs by incorporating multiplicity of fiber bundle packaged three-in-one R-G-B LEDs in a light box for direct-lit mode and eliminate the use of thick diffusers that impose light loss.

Further object of this invention is to provide a backlight unit for backlighting LCDs by incorporating multiplicity of fiber bundle packaged three-in-one R-G-B LEDs in a light box for direct-lit mode and reduce the thickness of backlight unit.

### BRIEF DESCRIPTION OF DRAWINGS

FIG. 1 is a cross-section, according to a prior art in which a unique lens directs the light rays coming from LED towards the side.

FIG. 2 is a cross-section of LCD backlight unit in which multiplicity of LEDs (only two LEDs are shown for simplicity) are assembled with a predetermined pitch inside unique lens structure of FIG. 1. The light rays from LEDs are mixed and sent upwards for backlighting LCD.

FIG. 3 shows the cross section, according to another prior art, of improved dome shape lens configuration that is placed over red, blue and green LEDs for directing the rays down to a reflecting sheet and thereby mixing the colors.

FIG. 4 is an isometric view of pre-mixing of R-G-B colors coming off red, blue and green LEDs inside a cylindrical package.

FIG. 5 is the isometric view of fiber mixed R-G-B LED white according to the present invention. A fiber bundle is sealed over the package shown in FIG. 4 for final mixing of colors.

FIG. 6 is an isometric view, according to another embodiment of present invention, of tapered or ‘fanned-out’ fiber bundle over the three-in-one package.

FIG. 7a is an isometric view of the assembly of fiber mixed R-G-B LEDs, according to the present invention, forming a ‘direct-lit’ backlight unit for LCD.

FIG. 7b is the cross-sectional view taken from FIG. 7a illustrating for the sake of simplicity only two fiber-mixed LED package.

FIG. 8a is a plan view of edge-lit backlight for LCD, according to the present invention, using fiber mixed R-G-B LED package.

FIG. 8b is the cross-section taken from FIG. 8a.

### DETAILED DESCRIPTION OF DRAWINGS

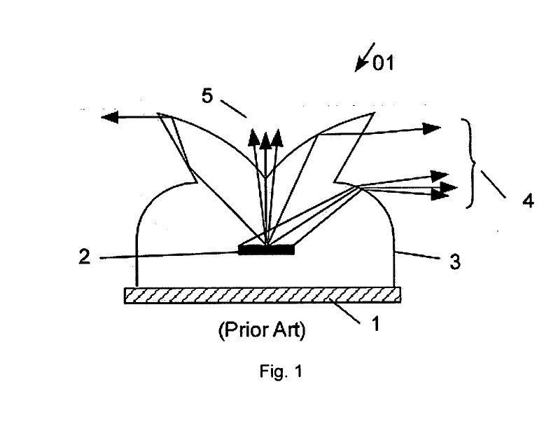

FIG. 1 is a cross-section, according to a prior art (U.S. Pat. No. 6,679,621) in which a unique lens 3 assembled on substrate 1 that contains PCB with heat sink for LED 2. The rays directed sideward are shown as 4 and the rays about 5% that goes vertically upward from LED is shown as 5.

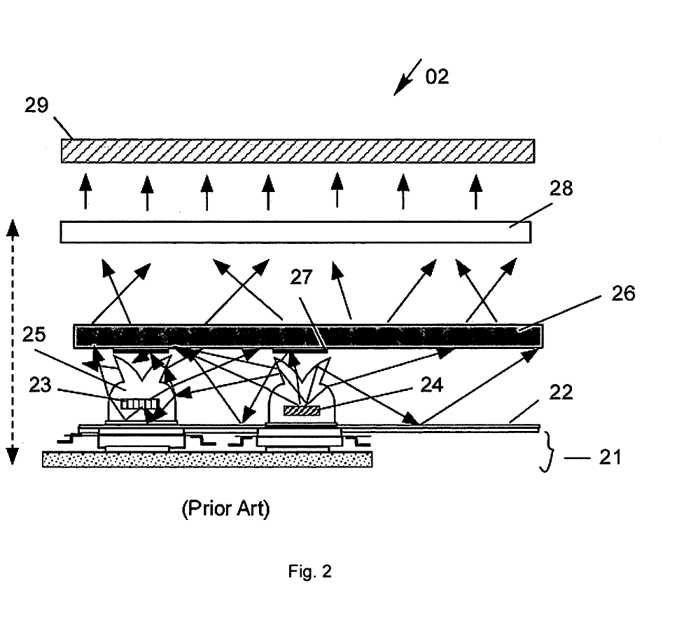

FIG. 2 is a cross-section of LCD backlight unit in which multiplicity of LEDs (only two LEDs are shown for simplicity) are assembled with a predetermined pitch inside unique lens structure of FIG. 1. As an example red LED 23 and blue LED 24 are assembled on PCB with heat sink 21. A reflective sheet 22 serves as bottom reflector. The unique lens 25, assembled over LEDs 23 and 24, directs the rays horizontally and downward as shown by arrows. A stop 27 is placed over each LED to prevent 5% of the rays reaching directly to the diffuser 26. Between the diffuser 26 and reflecting surface 22 the rays of colored light from LEDs undergo multiple reflections and get mixed. Further mixing takes place at the diffuser 26. In practice it was found that the mixing after diffuser 26 was not sufficient and hence another diffuser and additional optical sheets 28 are placed above the diffuser 26. Finally well mixed white light illuminates the LCD 29. A minimum distance of d˜50 mm is found necessary for mixing and hence the backlight unit needs to be at least 50 mm thick.

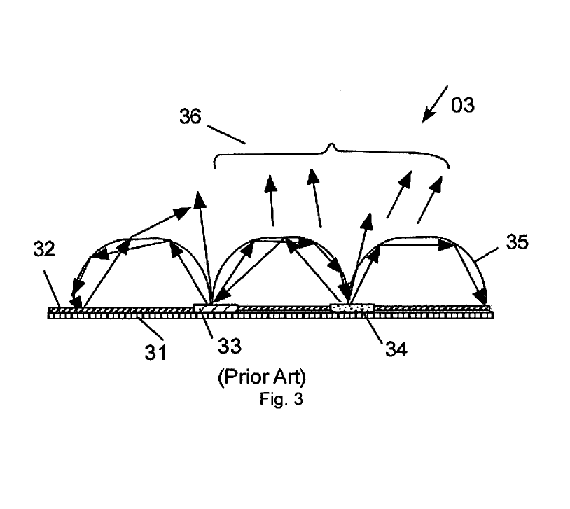

FIG. 3 shows the cross section, according to another prior art (US Patent Application No. 20050264716), of improved dome shape lens configuration 35 that is placed over red LED 33 and blue LED 34 (only two are shown for simplicity). Heat sink with PCB 31 carries a reflective surface 32 for reflection and color mixing. The rays starting from LEDs undergo several total internal reflections at the dome and incident on the reflective surface 32 and on LED chip and thus get mixed. Finally the white rays 36 emerge out of the lens structure and travel toward set of diffusers, not shown in FIG. 3.

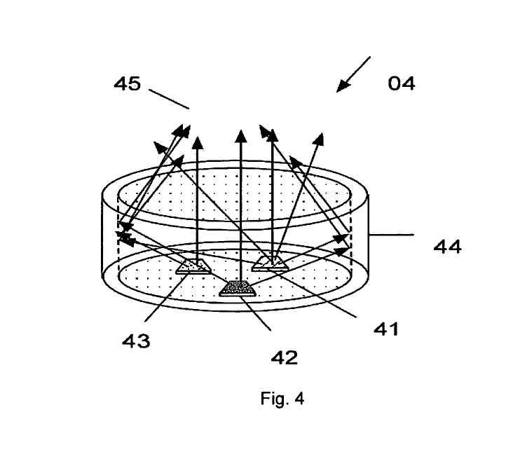

FIG. 4 is an isometric view of pre-mixing of R-G-B colors, according to another prior art (Michael J. Zwanenburg et. al—“High efficiency LEDs for LCD backlights”—SID '04 Digest of Technical papers, pp. 1222-1225, May, 2004). Color rays are emitted from red LED 41, blue LED 42 and green LED 43. The colored light rays from LEDs undergo reflection at the inner surface of the small package 44 and emerge as pre-mixed white light rays 45. The mixing is not complete.

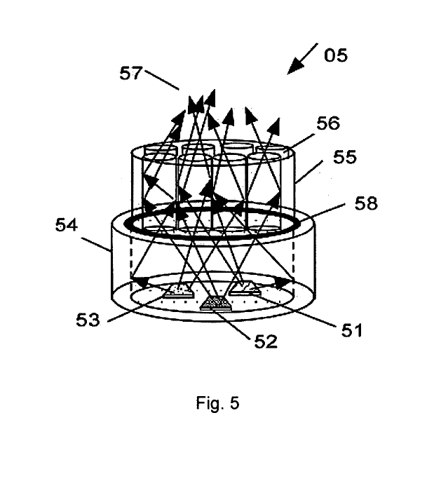

FIG. 5 is the isometric view of fiber mixed R-G-B LED white according to the present invention. A fiber bundle 55 is sealed over the package shown in FIG. 4. The fiber bundle comprises several fibers 56 such as the ones made of silica surrounded by a cladding material of lower refractive index than silica core. For example if the silica core has a refractive index of 1.45 the cladding material should have a refractive index of 1.40. A plastic cladding (not shown in FIG. 5) can also be incorporated around the fiber. The spacing between the fibers can be in the range of 125 microns to 500 microns. The space between the cladding around individual fibers can be filled and cured with a sealant material (not shown in FIG. 5) such as UV curable epoxy. The fiber bundle 55 has its end face well polished to receive light from the LED package without loss and is sealed hermetically around the container 54 through a seal 58 employing, for example, a UV curable epoxy. The container is flushed with Nitrogen during UV epoxy seal to keep the container free from moisture and enclose Nitrogen inside the container. The fibers 56 guide the colored light through total internal reflection upward. Colored light from red LED 51, blue LED 52 and green LED 53 fall on the inner surface of walls of the package container 54 which is reflecting and the reflected light rays, pre-mixed colors, from the walls are incident on the inner surface of fibers. All three R-G-B colored lights which are not well mixed after reflection from the walls are now having another chance of mixing by entering the inner surface of fibers. Finally, well mixed white light 57 emerges from the fiber bundle and travel upwards to LCD.

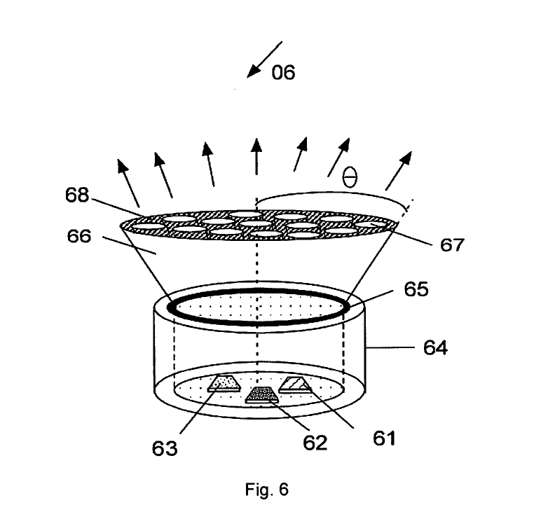

FIG. 6 is an isometric view, according to another embodiment of the present invention, of a tapered or fanned-out fiber bundle 66 which has both end faces polished to minimize light loss and is hermetically sealed to the three-in-one LED container 64 at the mouth of the container with a sealant 65 such as UV curable epoxy. During the sealing, the container is flushed with Nitrogen to keep the container and the surroundings of red LED 61, blue LED 62 and green LED 63 free from moisture. The space between the fibers 67 that have cladding is filled with UV epoxy 68, or any thermal epoxy resign that would not impose stress on the fibers, and cured without air bubble trap. The refractive index criterion for fiber core and cladding as stated under description of FIG. 5 remains the same for fanned-out fiber bundle as well. The half angle θ can be changed for any desired fiber bundle to suit the application of fiber mixed R-G-B white light.

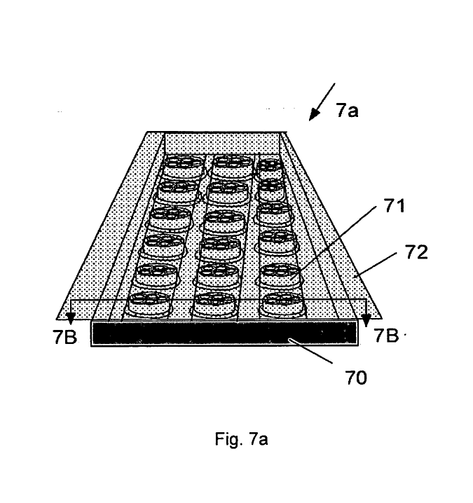

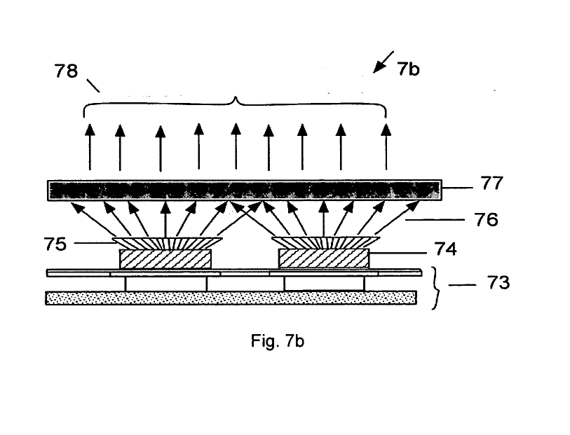

FIG. 7a shows the top down slanted view of a direct-lit backlight unit for backlighting LCDs. The fiber mixed R-G-B white LED packages 71 are arranged in rows and columns inside a light box 70 and a low density diffuser sheet 72 is laid over the light box. The white light travels upwards, not shown in FIG. 7, to illuminate LCD. A cross-section along the line 7B-7B is illustrated in FIG. 7b.

FIG. 7b is a cross-section along the line 7B-7B of FIG. 7a except that only two fiber-mixed R-G-B LED packages are shown for simplicity. The two three-in-one LED containers 74 sealed to the fanned-out fiber bundle 75 are assembled on PCB with heat sink 73 and the fiber-mixed white light 76 emerges from these packages and incident on mild diffuser 77 for final mixing with diverging angle such that the rays from the two adjacent fiber-mixed LED packages overlap leading to good uniformity of brightness after emerging from the diffuser and going towards LCD upwards as bundle of white rays 78.

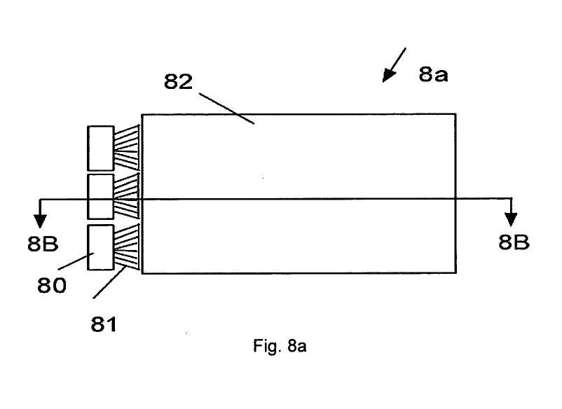

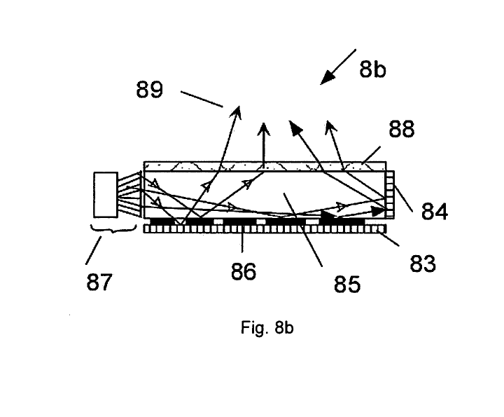

FIG. 8a is a plan view of fiber-mixed R-G-B white LED packages assembled at the edge of ‘edge-lit’ backlight unit for LCD. The three-in-one LED containers 80 with the fanned-out fiber bundles 81 sealed to the containers are assembled at the edge of a light guide 82 that converts the divergent discrete bundle of white light in to a continuous sheet of light that travels upwards to the back of LCD. A cross-section taken along 8B-8B is shown for clarity in FIG. 8b.

FIG. 8b is a cross-sectional view of FIG. 8a along the line 8B-8B. The fiber-mixed R-G-B LED package 87 is assembled at the edge of a light guide 85 to be in close contact with the edge face of the light guide. The reflector 83, dot pattern 86, the diffuser 88 and edge reflector 84 serve to extract light from the light guide and convert the beam source of light in to uniform sheet source of light 89 for use by the LCD. The light guide is made of acrylic and surfaces have optical finish to accomplish the task of conversion to uniform sheet of light. The light guide shown in FIG. 8b is for illustration only and there are various improved version of this light guide that do not employ reflector 83 and dot pattern 86 but instead employ grooved prisms. Similarly on top of the light guide prismatic structures are molded.

From the foregoing description it is clear that the mixing is done thoroughly by fiber bundle and there is minimum loss of light during this process as the mixing is through total internal reflection inside the fibers. Hence the backlight units employing fiber-mixed R-G-B white LED package will be thinner than the units made using prior art with less light loss. Fiber-mixed R-G-B white LED packages can be applied in Bill-Board Displays, consumer lighting and automobile lighting where rich white light with good color rendering index is required.

It will be understood that one skilled in the art could modify the above basic design dimensions, geometries, sequence of assemblies. Various modification and variations can be made in the construction, configuration and/or operation of the present invention without departing from the scope or spirit of the invention. By way of example, the fiber bundle can be modified to any geometry by shaping it to suit various applications. The cross-section of the fiber bundle at the exit end is circular in the foregoing description. This can be made oval for certain applications like the ‘edge-lit’ backlight. The fiber bundle can be made as ‘multi-core’ bundle. The individual fiber dimensions can be modified or the material of fiber can be made of glass or plastic with different cladding materials and the spacing between fibers can be changed. The geometry of the three-in-one LED container can be modified or instead of three-in-one LED any number of ‘n’ LEDs with different colors can be assembled inside the container.

Thus it is intended that the present invention covers the modifications and variations of the invention provided they come within the scope of the appended claims and their equivalents.

We claim:

1. A fiber bundle mixed R-G-B white LED package comprising:
a red LED, a blue and a green LED inside a container that posses reflecting surface which reflects red, blue and green color light and premixes three colors;
said container providing pre-mixed white light to a fiber bundle;
said fiber bundle containing multiplicity of fibers with cladding and having both the end faces polished and hermetically sealed to the mouth of the container that contains red, blue and green color LEDs;
said fibers and cladding possessing refractive indices such that the refractive index of fiber material is greater than the refractive index of cladding material;
said fiber bundle receiving pre-mixed white light from the said container and making the remaining unmixed colored light rays to undergo total internal reflections on its inner surfaces and guiding the light, as they mix thoroughly, to the exit face of fiber bundle and the light beam exiting at any desired angle;
said exit face of the fiber bundle sending white light in a preferential direction;
said fiber bundle and container both functioning as mixers of colored light, resulting in white emission from the exit end of the fiber bundle.

2. A fiber bundle mixed R-G-B white LED package as recited in claim 1 wherein the said container can contain ‘n’ number of LEDs of any color or many colors or combination of colors.

3. A fiber bundle mixed R-G-B white LED package as recited in claim 1 wherein the said container can be any geometrical shape.

4. A fiber bundle mixed R-G-B white LED package as recited in claim 1 wherein the said fiber bundle is a multi-core made of fibers of silica or plastic clad with organic or inorganic materials.

5. A fiber bundle mixed R-G-B white LED package as recited in claim 1 wherein the said fiber bundle is hermetically sealed to the said container with UV curable epoxy or thermal resin.

6. A fiber bundle mixed R-G-B white LED package as recited in claim 5 wherein the said fiber bundle is hermetically sealed to the said container by enclosing Nitrogen.

7. A fiber bundle mixed R-G-B white LED package as recited in claim 1 wherein the said fiber bundle has a jacket made of polyimide or Teflon or Mylar or Parylene.

8. A fiber bundle mixed R-G-B white LED package as recited in claim 1 wherein the said fiber bundle has the space between the fibers filled with UV epoxy or thermal epoxy.

9. A fiber bundle mixed R-G-B white LED package as recited in claim 1 wherein the said fiber bundle is shaped to be a ‘fanned-out’ configuration or straight cylindrical configuration or any geometrical configuration.

10. A fiber bundle mixed R-G-B white LED package as recited in claim 1 wherein the said fiber bundle has the cross-section of exiting face oval or circular or rectangular or triangular configuration.

11. A fiber bundle mixed R-G-B white LED package as recited in claim 10 wherein the said package is used as white light source in multiple or single in consumer lighting or automobile lighting or bridge lighting or decorative lighting applications.

12. A fiber bundle mixed R-G-B white LED package as recited in claim 10 wherein the said package is used in multiples for direct-lit backlight for backlighting Liquid Crystal Display.

13. A fiber bundle mixed R-G-B white LED package as recited in claim 10 wherein the said package is used in multiples for edge-lit backlight for backlighting Liquid Crystal Display.

14. A fiber bundle mixed R-G-B white LED package as recited in claim 10 wherein the said package is used in multiples in large area display.

15. A fiber bundle mixed R-G-B white LED package as recited in claim 2 wherein the said package is used in multiples in large area display for indoor or outdoor application.
